(19) United States
(12) Patent Application Publication
(10) Pub. No.: US 2007/0053587 A1
(43) Pub. Date: Mar. 8, 2007

(54) Techniques to improve contrast enhancement using a luminance histogram

(76) Inventor: Walid S. Ali, Chandler, AZ (US)

Correspondence Address: KACVINSKY LLC;C/O INTELLEVATE, P.O. BOX 52050, MINNEAPOLIS, MN, 55402, US

(21) Appl. No.: 11/211,402

(22) Filed: Aug. 24, 2005

(51) Int. Cl. G06K 9/00

(52) U.S. Cl. 382/168

(57) ABSTRACT

An apparatus, system, method, and article for enhancing video sharpness are described. The apparatus may include a media processing node having a contrast enhancement module. The contrast enhancement module may receive an input image having multiple luminance regions, and create an output image using a luminance histogram and a luminance transfer function that produces a continuous luminance transfer curve having multiple segments, with each segment corresponding to one of the luminance regions. Other embodiments are described and claimed.

### BACKGROUND

Sharpness is a perceptual feature, which is determined by the human visual system. Techniques to improve contrast between lighter regions and darker regions within an image may improve the sharpness of an image. Such techniques, however, may require complex hardware or produce irritating artifacts that reduces the overall impression of sharpness improvement.

### BRIEF DESCRIPTION OF THE DRAWINGS

FIG. 1 illustrates one embodiment of a media processing system.

FIG. 2 illustrates one embodiment of a media processing sub-system.

FIG. 3 illustrates one embodiment of an input image and a luminance histogram for the input image.

FIG. 4 illustrates one embodiment of an output image and a luminance histogram for the output image.

FIG. 5 illustrates one embodiment of a graph for a luminance transfer function.

FIG. 6 illustrates one embodiment of a logic flow.

### DETAILED DESCRIPTION

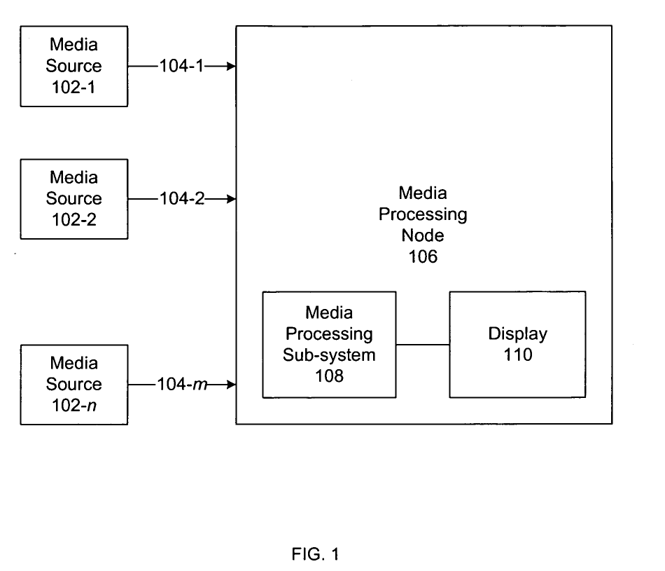

FIG. 1 illustrates one embodiment of a system. FIG. 1 illustrates a block diagram of a system 100. In one embodiment, for example, system 100 may comprise a media processing system having multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, the communications system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television System Committee (NTSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of system 100 may be arranged to communicate, manage or process different types of information, such as media information and control information. Examples of media information may generally include any data representing content meant for a user, such as voice information, video information, audio information, image information, textual information, numerical information, alphanumeric symbols, graphics, and so forth. Control information may refer to any data representing commands, instructions or control words meant for an automated system. For example, control information may be used to route media information through a system, to establish a connection between devices, instruct a node to process the media information in a predetermined manner, and so forth. The embodiments are not limited in this context.

In various embodiments, system 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media. An example of wireless communication media may include portions of a wireless spectrum, such as the RF spectrum. The wireless nodes may include components and interfaces suitable for communicating information signals over the designated wireless spectrum, such as one or more antennas, wireless transmitters/receivers (“transceivers”), amplifiers, filters, control logic, antennas, and so forth. The embodiments are not limited in this context.

In various embodiments, system 100 may comprise a media processing system having one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a Digital Versatile Disk (DVD) device, a Video Home System (VHS) device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720p), which refers to 720 vertical pixels and 1280 horizontal pixels (720×1280). In another example, the media information may have a visual resolution format corresponding to various computer display formats, such as a video graphics array (VGA) format resolution (640×480), an extended graphics array (XGA) format resolution (1024×768), a super XGA (SXGA) format resolution (1280×1024), an ultra XGA (UXGA) format resolution (1600×1200), and so forth. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (CODEC), a filtering device (e.g., graphic scaling device, deblocking filtering device), a transformation device, an entertainment system, a display, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to vary a contrast level of an image or picture and perform other media processing operations as described in more detail below. Media processing sub-system 108 may output the processed media information to a display 110. The embodiments are not limited in this context.

In various embodiments, media processing node 106 may include a display 110. Display 110 may be any display capable of displaying media information received from media source nodes 102-1-n. Display 110 may display the media information at a given format resolution. For example, display 110 may display the media information on a display having a VGA format resolution, XGA format resolution, SXGA format resolution, UXGA format resolution, and so forth. The type of displays and format resolutions may vary in accordance with a given set of design or performance constraints, and the embodiments are not limited in this context.

In general operation, media processing node 106 may receive media information from one or more of media source nodes 102-1-n. For example, media processing node 106 may receive media information from a media source node 102-1 implemented as a DVD player integrated with media processing node 106. Media processing sub-system 108 may retrieve the media information from the DVD player, convert the media information from the visual resolution format to the display resolution format of display 110, and reproduce the media information using display 110.

In various embodiments, media processing node 106 may be arranged to receive an input image from one or more of media source nodes 102-1-n. The input image may comprise any data or media information derived from or associated with one or more video images. In one embodiment, for example, the input image may comprise a picture in a video sequence comprising signals (e.g., Y, U, and V) sampled in both the horizontal and vertical directions. In various embodiments, the input image may comprise one or more of image data, video data, video sequences, groups of pictures, pictures, images, regions, objects, frames, slices, macroblocks, blocks, pixels, signals, and so forth. The values assigned to pixels may comprise real numbers and/or integer numbers.

In various embodiments, media processing node 106 may be arranged to perform sharpness enhancement on a received input image. The luminance of a picture in a video sequence may describe the amount of brightness of one or more pixels of the picture. When combined with the overall luminance values of the remaining pixels in the picture, this will give an overall impression of the variation between lighter regions (portions) and darker regions (portions) of the picture. This may determine a perceived level of contrast in the video sequence. Widening the luminance difference between lighter and darker regions may improve perception of the picture by the human visual system, which in turn may result in a perceived increase in the depth and sharpness of the picture.

Conventional techniques to increase the luminance difference between lighter and darker regions in order to vary the contrast level of a picture, however, may be undesirable for a number of reasons. For example, one technique performs contrast enhancement by building and modifying a histogram using a number of joined linear segments. Such techniques rely upon detecting control points using computationally expensive analysis of a luminance histogram to produce a number of joint linear segments to approximate a transfer function between the luminance at the input and output. A luminance histogram may provide, for example, a luminance distribution for an image. These techniques, however, are relatively complex and expensive to implement. In addition, the joints points where two linear segments connect may have a relatively strong discontinuity that results in an abrupt and severe transition. This may result in the creation of an undesirable artificial shadow, contours, bands, artifacts, and so forth.

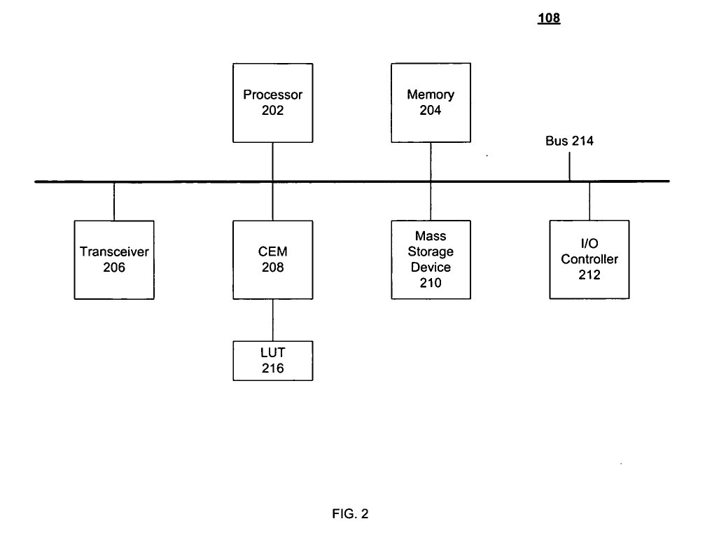

Some embodiments attempt to solve these and other problems. In various embodiments media processing sub-system 108 of media processing node 106 may be arranged to perform contrast or sharpness enhancement on the received input image. In one embodiment, for example, media processing sub-system 108 may include a contrast enhancement module. The contrast enhancement module may be arranged to receive an input image having multiple luminance regions, and create an output image using a luminance histogram and a luminance transfer function that produces a continuous luminance transfer curve having multiple segments, with each segment corresponding to one of the luminance regions. The luminance histogram may provide a luminance distribution for an image. The luminance histogram may group pixels for an image according to luminance values within certain luminance value ranges. The luminance histogram may be used to determine how many pixels are within a given luminance value range, and further, what percentage such pixels represent relative to the overall number of pixels within an image. In one embodiment, the luminance transfer function may comprise one or more predefined or predetermined mathematical functions to change the luminance of an input image in order to achieve a perception of stronger contrast enhancement. System 100 in general, and media processing sub-system 108 in particular, may be described in more detail with reference to FIG. 2.

FIG. 2 illustrates one embodiment of a media processing sub-system 108. FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include a transceiver 206. Transceiver 206 may be any radio transmitter and/or receiver arranged to operate in accordance with a desired wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1xRTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In one embodiment, for example, media processing sub-system 108 may include a contrast enhancement module (CEM) 208. CEM 208 may be used to adjust a contrast level for an input image. In one embodiment, CEM 208 may be arranged to perform sharpness or contrast enhancement on the received input image. CEM 208 may utilize one or more predefined or predetermined mathematical luminance transfer functions to change the luminance of an input image in order to achieve a perception of stronger contrast enhancement. For example, the predetermined mathematical functions may be stored in any suitable storage device, such as memory 204, a mass storage device (MSD) 210, a hardware-implemented lookup table (LUT) 216, and so forth. It may be appreciated that CEM 208 may be implemented-as software executed by processor 202, dedicated hardware such as a media processor or circuit, or a combination of both. The embodiments are not limited in this context.

In various embodiments, media processing sub-system 108 may include a MSD 210. Examples of MSD 210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

In general operation, media processing sub-system 108 may receive media information from one or more media source nodes 102-1-n. For example, media source node 102-1 may comprise a DVD device connected to processor 202. Alternatively, media source 102-2 may comprise memory 204 storing a digital AV file, such as a motion pictures expert group (MPEG) encoded AV file. CEM 208 may operate to receive the media information from mass storage device 216 and/or memory 204, process the media information (e.g., via processor 202 and/or CEM 208), and display the media information on display 110.

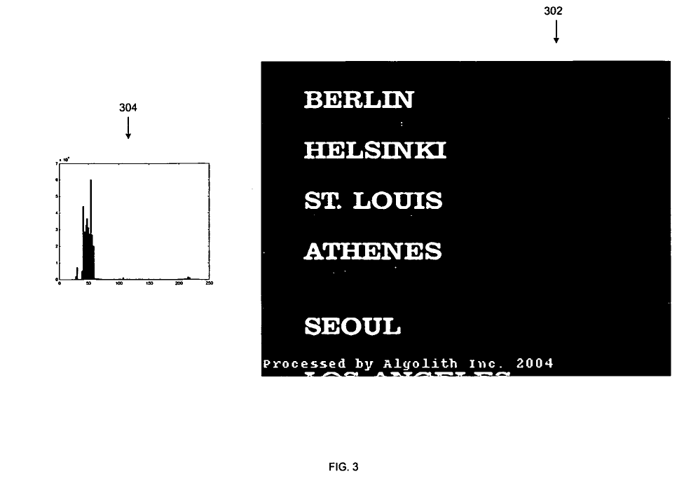

As previously described, CEM 208 may utilize one or more mathematical luminance transfer functions to change the luminance of an input image in order to achieve a perception of stronger contrast enhancement. For example, media processing node 106 may receive an input image having a first level of contrast, and create an output image having a second level of contrast using a luminance histogram and a certain luminance transfer function. Media processing node 106 may accomplish this using CEM 208 of media processing sub-system 108. CEM 208 may retrieve a predefined or predetermined luminance transfer function from memory. In one embodiment, for example, the luminance transfer function may be stored in LUT 216. CEM 208 may use the luminance transfer function to modify a luminance value for one or more pixels to vary the contrast of the input image thereby creating the output image. Prior to creating the output image, CEM 208 may perform some initial operations to determine whether to use the luminance transfer function to modify the contrast of the input image. In one embodiment, for example, these determinations may be performed by generating and analyzing a luminance histogram for the input image. These and other luminance transfer operations may be described in more detail with reference to FIGS. 3-6.

FIG. 3 illustrates one embodiment of an input image and a luminance histogram for the input image. FIG. 3 illustrates an input image 302 and a luminance histogram 304 of input image 302. As shown by luminance histogram 304, a relatively large number of pixels from the total number of pixels of input image 302 have a luminance value somewhere between 40 and 60. Conversely, there are relatively fewer pixels within the lower luminance value range of 0-25 and the higher luminance value range of 225-255. Typically the lower luminance values represent darker portions or regions of input image 302, while the higher luminance values represent lighter (brighter) portions or regions of input image 302. The midrange values typically represent varying degrees of brightness between the darker and lighter regions of input image 302. It may be appreciated, however, that such representations may change as desired for a given implementation (e.g., higher luminance values may be representative of darker regions). The embodiments are not limited in this context.

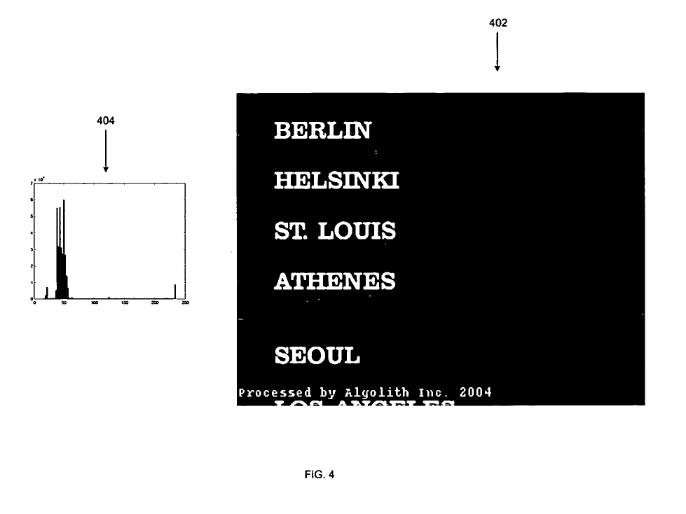

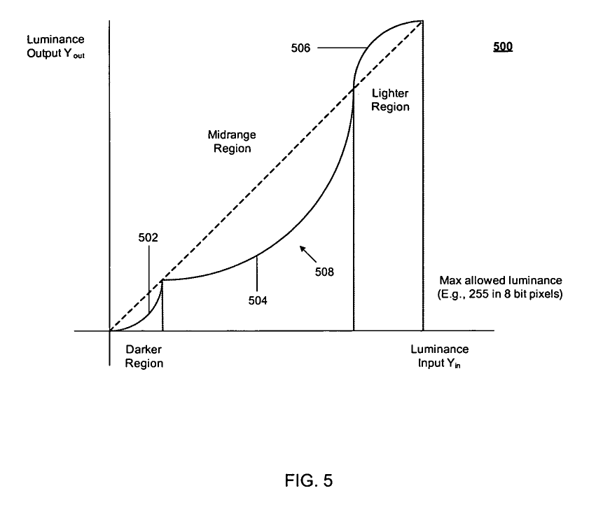

FIG. 4 illustrates one embodiment of an output image and a luminance histogram for the output image. FIG. 4 illustrates an output image 402 and a luminance histogram 404 of input image 402. Output image 402 may represent an image after processing by CEM 208. As shown by luminance histogram 404, a relatively large number of pixels from the overall number of pixels of output image 402 still have a luminance value somewhere between 40 and 60, although the specific percentages of pixels within the 40-60 range have been somewhat modified. Similarly, there still remain relatively fewer pixels within the lower luminance value range of 0-25 in output image 402. The number of pixels toward the higher luminance value range of 225-255 as shown in luminance histogram 404, however, has been increased relative to the higher luminance value range of 225-255 as shown in luminance histogram 304 after processing by CEM 208. As indicated by luminance histogram 404, CEM 208 has modified the contrast level of input image 302 using a luminance transfer function when creating output image 402, thereby creating output image 402 with a higher degree of sharpness, depth and crispness relative to input image 302. The luminance transfer function used by CEM 208 may be described in further detail with reference to FIG. 5.

FIG. 5 illustrates one embodiment of a graph for a luminance transfer function. Graph 500 illustrates an example of a luminance input/output transfer function suitable for use by CEM 208 to perform contrast adjustment and contrast enhancement of an image. More particularly, assuming 8 bit pixel values, graph 500 illustrates a luminance input Yᵢₙ on the X axis having a range of values between 0-255 and a luminance output Yₒᵤₜ on the Y axis having a range of values between 0-255. A luminance transfer function may be used to change one or more luminance values for corresponding pixels of an image in order to vary the contrast of the image. Many functions could be used for warping the luminance of an input image to an improved contrast luminance at the output image.

In one embodiment, for example, the changes (re-mapping) of the luminance values of an input image could be performed by a luminance transfer function arranged to produce a luminance transfer curve 508 comprising multiple segments, as shown in graph 500. As shown in graph 500, luminance transfer curve 508 may comprise three luminance curve segments 502, 504 and 506. Segment 502 may correspond to a darker region (lower luminance values) for an image. Segment 504 may correspond to a midrange region (midrange luminance values) for an image. Segment 506 may correspond to a lighter region (higher luminance values) for an image. Each segment may represent a polynomial of a certain degree. In one embodiment, for example, a given luminance transfer curve should be selected to provide substantial unity (e.g., a first degree polynomial) in the midrange region, while reducing discontinuities at the joint points between segments 502, 504 and segments 504, 506. Although graph 500 provides an example of such a luminance transfer curve, it may be appreciated that other luminance transfer functions may be used as well as desired for a given implementation. The embodiments are not limited in this context.

As shown in graph 500, CEM 208 uses the luminance transfer function to transfer or change a first set of luminance values of luminance input Yᵢₙ (e.g., input image 302) to a second set of luminance values of luminance output Yₒᵤₜ (e.g., output image 402) along luminance transfer curve 508 of graph 500. Luminance transfer curve 508 may create an output image with an improved picture quality relative to the input image by using the luminance transfer function to increase a first set of pixel values for a first set of pixels representing lighter portions of the input image, and decrease a second set of pixel values for a second set of pixels representing darker portions of the input image.

In general operation, CEM 208 may receive input image 302 having multiple luminance regions, such as a darker region, a midrange region, and a lighter region. CEM 208 may create output image 402 using luminance histogram 204 and a luminance transfer function that produces a continuous luminance transfer curve (e.g., luminance transfer curve 508) having multiple segments (e.g., 502, 504 and 506). Segments 502, 504 and 506 may correspond to the darker region, the midrange region and the lighter region of input image 302, respectively. The embodiments are not limited in this context.

In various embodiments, CEM 208 may determine whether to modify one or more luminance values within the luminance regions using luminance histogram 304 to create output image 402. In one embodiment, for example, CEM 208 may identify a first percentage of pixels having luminance values within the darker region and a second percentage of pixels having luminance values within the lighter region using luminance histogram 304. CEM 208 may determine to modify one or more luminance values within one or more luminance regions if the first percentage is within a first predetermined threshold percentage and the second percentage is within a second predetermined threshold percentage. This may be described in more detail using the following example.

In one embodiment, for example, CEM 208 may be arranged to generate and/or analyze a luminance histogram for every picture or image in a video sequence. CEM 208 may generate or build a luminance histogram to identify how many pixels have a particular luminance value range. The luminance histogram, such as luminance histogram 304, may be used to determine whether to modify luminance values within the darker and/or lighter regions of input image 302 using corresponding luminance curve segments 502, 506, respectively.

In one embodiment, for example, CEM 208 may identify a first percentage of pixels having luminance values within the darker region using luminance histogram 304. For example, assume a value of 1% is defined for the darkest luminance percentage within the darker region. In this case, the darkest luminance percentage would represent the bottom 1% of the total number of luminance values available for input image 302. Assuming each luminance value is represented using 8 bits, the total number of luminance values would be 256 (or rather 0-255). The bottom 1% of 256 possible luminance values would be those pixels having a luminance value between approximately 0 and 3. An example of a first percentage of pixels may represent the number of pixels within input image 302 having a luminance value within the defined darkest luminance percentage, which in this example is between 0-3 (or ˜1%). As shown in luminance histogram 304, the number of pixels within the bottom 1% appears to be 0, therefore in this case the first percentage would be 0 divided by the total number of pixels for input image 302. Assuming input image 302 is an image from an HDTV signal having a resolution of 720p, the first percentage would be 0 divided by 921600 total pixels or 0%. This percentage of pixels may represent the darkest portion of input image 302, that is, the blackest black in the luminance component. CEM 208 may then compare the first percentage to a first predetermined threshold percentage. The first predetermined threshold percentage may be any percentage, but should be sufficient to ensure there are enough pixels within the darker region to benefit from contrast enhancement. In one embodiment, for example, the first predetermined threshold percentage may comprise 10% of a total number of pixels within input image 302. Since the first percentage of 0% is within the first predetermined threshold percentage of 10% for the darker region, then the luminance values for the darker region of input image 302 may be modified using segment 502 of luminance transfer curve 508.

In one embodiment, for example, CEM 208 may also identify a second percentage of pixels having luminance values within the lighter region using luminance histogram 304. For example, assume a value of 5% is defmed for the lightest (brightest) luminance percentage within the lighter region. In this case, the lightest luminance percentage would represent the top 5% of the total number of luminance values available for input image 302. Assuming again that each luminance value is represented using 8 bits, the top 5% of 256 possible luminance values would be those pixels having a luminance value between approximately 242 and 255. An example of a second percentage of pixels may represent the number of pixels within input image 302 having a luminance value within the defined lightest luminance percentage, which in this example is between 242-255 (or 5%). As shown in luminance histogram 304, the number of pixels within the top 5% appears to be approximately 1×10⁴ or 10000 pixels. Therefore in this case the second percentage would be 10000 divided 912600 or 1%. This percentage of pixels may represent the lightest portion of input image 302, that is, the whitest white in the luminance component. CEM 208 may then compare the second percentage to a second predetermined threshold percentage. As with the first predetermined threshold percentage, the second predetermined threshold percentage may be any percentage, but should be sufficient to ensure there are enough pixels within the lighter region to benefit from contrast enhancement. In one embodiment, for example, the second predetermined threshold percentage may comprise 10% of a total number of pixels within input image 302. Since the second percentage of 1% is within the first predetermined threshold percentage of 10% for the lighter region, then the luminance values for the lighter region of input image 302 may be modified using segment 506 of luminance transfer curve 508.

In one embodiment, for example, the luminance values for the midrange region of input image 302 may be modified using segment 504 of luminance transfer curve 508. Unlike the darker region or lighter region, it is assumed that the midrange region has sufficient luminance values to benefit from contrast enhancement, and therefore the determination made with respect to the darker region and lighter region is not necessarily needed. As previously described, segment 504 should comprise a luminance transfer curve segment having substantial unity in the midrange region, while attempting to reduce discontinuities at the joint points between segments 502, 504 and segments 504, 506. Luminance transfer curve 508 is an example of a luminance transfer curve having piecewise linear segments arranged to smooth the joint points by preserving curve continuity at piecewise polynomial approximating curves. Thus luminance transfer curve 508 potentially avoids producing banding/contouring artifacts that may result from conventional piecewise linear transfer curves when neighboring regions of an input image belong to different luminance ranges on the input of the luminance transfer curve. The embodiments are not limited in this context.

It may be appreciated that the specific values described above with respect to CEM 208 are given by way of example only. Other values may also be implemented as desired for a given implementation. The embodiments are not limited in this context.

In various embodiments, CEM 208 may increase a first set of luminance values for a lighter region of the input image relative to an absolute maximum luminance value for the input image, and decrease a second set of luminance values for a darker region of the input image relative to an absolute minimum luminance value for the input image. This may improve the picture quality of the output image by stretching the luminance extremes, such as the darkest dark pixels and the brightest bright pixels, into the maximum possible values for dark black and bright white. In one embodiment, the absolute maximum luminance value may be 255 for bright white, and the absolute minimum luminance value may be 0 for dark black, assuming an 8 bit per pixel representation. This may be a desirable feature since this technique enhances the overall perceived sharpness and perceived impression of depth in video sequences.

In one embodiment, for example, CEM 208 may identify a minimum luminance value within the darker region and a maximum luminance value within the lighter region. CEM 208 may modify the minimum luminance value for the darker region to an absolute minimum luminance value for the input image. CEM 208 may modify any remaining luminance values for the darker region relative to the absolute minimum luminance value. CEM 208 may also modify the maximum luminance value for the lighter region to an absolute maximum luminance value for the input image. CEM 208 may modify any remaining luminance values for the lighter region relative to the absolute maximum luminance value.

In one embodiment, for example, the two sets of points for the darker region and lighter region represent the extremes in the luminance distribution. The remaining points are the majority of the pixel values, or in this case, 94% of the pixels in input picture 302. CEM 208 re-maps the luminance distribution along the different luminance regions. For the darkest percentage of 1%, CEM 208 pushes the darkest value to absolute zero luminance and corrects the remaining points in this percentage accordingly. For the brightest region of 5%, CEM 208 pushes the brightest value to the absolute maximum luminance and corrects the remaining points in this percentage accordingly. For the remaining points in the midrange percentage of 94%, CEM 208 applies changes that cause a reduced amount of deviation from a unity transfer function between the input and output luminance, while keeping luminance transfer curve 508 as close as possible to continuity when joining transfer curve segments 502, 504 and transfer curve segments 504, 506. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

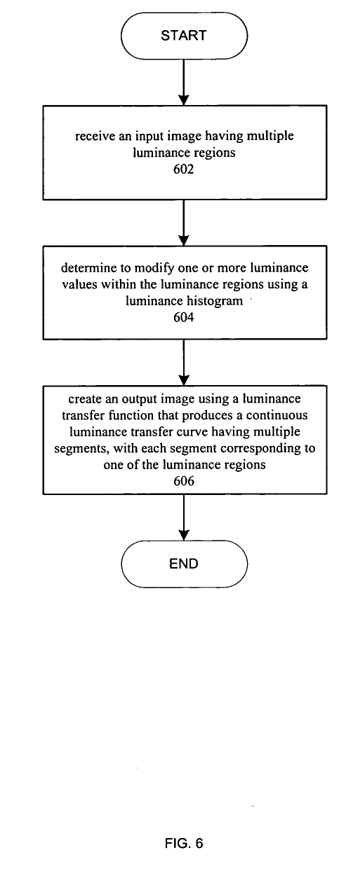

FIG. 6 illustrates one embodiment of a logic flow. FIG. 6 illustrates a logic flow 600. Logic flow 600 may be representative of the operations executed by one or more embodiments described herein, such as media processing system 100, media processing sub-system 108, and/or CEM 208. As shown in logic flow 600, an input image having multiple luminance regions may be received at block 602. A determination may be made as to whether to modify one or more luminance values within the luminance regions using a luminance histogram at block 604. An output image may be created using a luminance transfer function that produces a continuous luminance transfer curve having multiple segments, with each segment corresponding to one of the luminance regions, at block 606. The embodiments are not limited in this context.

In one embodiment, a first segment for the luminance transfer curve may correspond to a darker region for the input image, a second segment for the luminance transfer curve may correspond to a midrange region for the input image, and a third segment for the luminance transfer curve may correspond to a lighter region for the input image. The embodiments are not limited in this context.

In one embodiment, each segment may represent a polynomial of a certain degree. The second segment may represent a first degree polynomial selected to increase continuity at a first joint point between the first segment and the second segment, and a second joint point between the second segment and the third segment. The embodiments are not limited in this context.

In one embodiment, a first percentage of pixels having luminance values within a darker region may be identified using the luminance histogram. A second percentage of pixels having luminance values within a lighter region may be identified using the luminance histogram. A determination may be made to modify one or more luminance values within the luminance regions if the first percentage is within a first predetermined threshold percentage and the second percentage is within a second predetermined threshold percentage. The embodiments are not limited in this context.

In one embodiment, a minimum luminance value within the darker region and a maximum luminance value within the lighter region may be identified. The minimum luminance value for the darker region may be modified to an absolute minimum luminance value for the input image. The maximum luminance value for the lighter region may be modified to an absolute maximum luminance value for the input image. Any remaining luminance values for the darker region may be modified relative to the absolute minimum luminance value. Any remaining luminance values for the lighter region may be modified relative to the absolute maximum luminance value. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a media processing node having a contrast enhancement module, said contrast enhancement module to receive an input image having multiple luminance regions, and create an output image using a luminance histogram and a luminance transfer function that produces a continuous luminance transfer curve having multiple segments, with each segment corresponding to one of said luminance regions.

2. The apparatus of claim 1, said contrast enhancement module to determine whether to modify one or more luminance values within said luminance regions using said luminance histogram to create said output image.

3. The apparatus of claim 2, said contrast enhancement module to identify a first percentage of pixels having luminance values within a darker region and a second percentage of pixels having luminance values within a lighter region using said luminance histogram.

4. The apparatus of claim 3, said contrast enhancement module to determine to modify one or more luminance values within said luminance regions if said first percentage is within a first predetermined threshold percentage and said second percentage is within a second predetermined threshold percentage.

5. The apparatus of claim 4, said contrast enhancement module to identify a minimum luminance value within said darker region and a maximum luminance value within said lighter region, modify said minimum luminance value for said darker region to an absolute minimum luminance value for said input image and said maximum luminance value for said lighter region to an absolute maximum luminance value for said input image, and modify any remaining luminance values for said darker region relative to said absolute minimum luminance value and any remaining luminance values for said lighter region relative to said absolute maximum luminance value.

6. The apparatus of claim 1, said contrast enhancement module to increase a first set of luminance values for a lighter region of said input image relative to an absolute maximum luminance value for said input image, and decrease a second set of luminance values for a darker region of said input image relative to an absolute minimum pixel value for said input image.

7. A system, comprising:
a communications medium; and
a media processing node to couple to said communications medium, said media processing node having a contrast enhancement module, said contrast enhancement module to receive an input image having multiple luminance regions, and create an output image using a luminance histogram and a luminance transfer function that produces a continuous luminance transfer curve having multiple segments, with each segment corresponding to one of said luminance regions.

8. The system of claim 7, said contrast enhancement module to determine whether to modify one or more luminance values within said luminance regions using said luminance histogram to create said output image.

9. The system of claim 8, said contrast enhancement module to identify a first percentage of pixels having luminance values within a darker region and a second percentage of pixels having luminance values within a lighter region using said luminance histogram.

10. The system of claim 9, said contrast enhancement module to determine to modify one or more luminance values within said luminance regions if said first percentage is within a first predetermined threshold percentage and said second percentage is within a second predetermined threshold percentage.

11. The system of claim 10, said contrast enhancement module to identify a minimum luminance value within said darker region and a maximum luminance value within said lighter region, modify said minimum luminance value for said darker region to an absolute minimum luminance value for said input image and said maximum luminance value for said lighter region to an absolute maximum luminance value for said input image, and modify any remaining luminance values for said darker region relative to said absolute minimum luminance value and any remaining luminance values for said lighter region relative to said absolute maximum luminance value.

12. The system of claim 7, said contrast enhancement module to increase a first set of luminance values for a lighter region of said input image relative to an absolute maximum luminance value for said input image, and decrease a second set of luminance values for a darker region of said input image relative to an absolute minimum pixel value for said input image.

13. A method, comprising:
receiving an input image having multiple luminance regions;
determining to modify one or more luminance values within said luminance regions using a luminance histogram; and
creating an output image using a luminance transfer function that produces a continuous luminance transfer curve having multiple segments, with each segment corresponding to one of said luminance regions.

14. The method of claim 13, wherein a first segment corresponds to a darker region for said input image, a second segment corresponds to a midrange region for said input image, and a third segment corresponds to a lighter region for said input image.

15. The method of claim 14, wherein each segment represents a polynomial of a certain degree, and said second segment represents a first degree polynomial selected to increase continuity at a first joint point between said first segment and said second segment, and a second joint point between said second segment and said third segment.

16. The method of claim 13, comprising:
identifying a first percentage of pixels having luminance values within a darker region using said luminance histogram;
identifying a second percentage of pixels having luminance values within a lighter region using said luminance histogram; and
determining to modify one or more luminance values within said luminance regions if said first percentage is within a first predetermined threshold percentage and said second percentage is within a second predetermined threshold percentage.

17. The method of claim 16, comprising:
identifying a minimum luminance value within said darker region and a maximum luminance value within said lighter region;
modifying said minimum luminance value for said darker region to an absolute minimum luminance value for said input image and said maximum luminance value for said lighter region to an absolute maximum luminance value for said input image; and
modifying any remaining luminance values for said darker region relative to said absolute minimum luminance value and any remaining luminance values for said lighter region relative to said absolute maximum luminance value.

18. An article comprising a machine-readable storage medium containing instructions that if executed enable a system to receive an input image having multiple luminance regions, determine to modify one or more luminance values within said luminance regions using a luminance histogram, and create an output image using a luminance transfer function that produces a continuous luminance transfer curve having multiple segments with each segment corresponding to one of said luminance regions.

19. The article of claim 18, further comprising instructions that if executed enable the system to identify a first percentage of pixels having luminance values within a darker region using said luminance histogram, identify a second percentage of pixels having luminance values within a lighter region using said luminance histogram, and determine to modify one or more luminance values within said luminance regions if said first percentage is within a first predetermined threshold percentage and said second percentage is within a second predetermined threshold percentage.

20. The article of claim 19, further comprising instructions that if executed enable the system to identify a minimum luminance value within said darker region and a maximum luminance value within said lighter region, modify said minimum luminance value for said darker region to an absolute minimum luminance value for said input image and said maximum luminance value for said lighter region to an absolute maximum luminance value for said input image, and modify any remaining luminance values for said darker region relative to said absolute minimum luminance value and any remaining luminance values for said lighter region relative to said absolute maximum luminance value.
